(19) United States
(12) Patent Application Publication
(10) Pub. No.: US 2021/0365457 A1
(43) Pub. Date: Nov. 25, 2021

(54) GRAPH DATABASE AND METHODS WITH IMPROVED FUNCTIONALITY

(71) Applicant: VMware, Inc., Palo Alto, CA (US)

(72) Inventors: Steve Venema, Palo Alto, CA (US); Paul Dennis Allen, Bellevue, WA (US); Nandesh Guru, Palo Alto, CA (US); Andrew Armaneous, Palo Alto, CA (US); David Hanson, Bellevue, WA (US); Devid Mattes, Palo Alto, CA (US)

(73) Assignee: VMware, Inc., Palo Alto, CA (US)

(21) Appl. No.: 16/882,638

(22) Filed: May 25, 2020

(51) Int. Cl. G06F 16/2455; G06F 16/25; G06F 16/28; G06F 16/248; G06F 16/901; G06F 16/2452

(52) U.S. Cl. CPC G06F 16/24553; G06F 16/252; G06F 16/24528; G06F 16/248; G06F 16/9024; G06F 16/288

(57) ABSTRACT

The current document is directed to graph databases and, in particular, to improvements in the operational efficiencies of, and the range of functionalities provided by, graph databases. One currently disclosed improvement provides for associating user-defined and developer-defined functions with node and relationship entities stored within the graph database. These entity-associated functions are executed in entity-associated execution environments provided to the entities during query execution. Another currently disclosed improvement provides text-replacement-based preprocessing of graph-database queries for increased clarity and for increasing the speed and accuracy with which the queries can be formulated.

### TECHNICAL FIELD

The current document is directed to databases and database-management systems and is directed, in particular, to improved graph databases and to methods incorporated in the improved graph databases.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The capabilities of modern computer systems have provided an environment in which many different types of computer-implemented technologies, services, applications, and platforms have been developed and have rapidly advanced in functionalities and capacities.

One example of the advancement of applications and services can be found in the field of computer-implemented databases. Early on, data was stored in unstructured or structured files which could only be accessed and updated by a single user at any given point in time. Over the years, various types of database-management systems were developed, including network, hierarchical, and relational database-management systems. These database-management systems provide tools and logical models for organizing data, query languages for writing data to, reading data from, and updating data within the databases, and sophisticated locking and access protocols that permit concurrent access by hundreds, thousands, or more users while ensuring atomic updates, consistency, isolation of parallel transactions, and guaranteed commitments of updates and other transactions. More recently, additional types of databases have been developed, including object-oriented databases. NoSQL distributed databases, and graph databases. Graph databases employed a graph model for organizing data, with the term “graph” referring to the mathematical concept of a graph composed of nodes interconnected by edges. New types of databases, such as graph databases, are developed based on new data models to facilitate better organization of new types of data, to provide query-language functionalities and structures for accessing the new types data, and to facilitate new types of applications, but the new types of databases often lag behind mature databases in operational efficiency, protocols for robust and efficient transaction processing, and in other aspects important for real-world applications. Thus, developers, vendors, and users of database-management systems, particularly newer types of database-management systems, continue to seek improvements in the operational efficiencies and functionalities of these database-management systems so that they can be effectively used in large-scale and commercial applications and so that the functionalities provided by these database-management systems allow for fully exploiting the data models underlying them.

### SUMMARY

The current document is directed to graph databases and, in particular, to improvements in the operational efficiencies of, and the range of functionalities provided by, graph databases. One currently disclosed improvement provides for associating user-defined and developer-defined functions with node and relationship entities stored within the graph database. These entity-associated functions are executed in entity-associated execution environments provided to the entities during query execution. Another currently disclosed improvement provides text-replacement-based preprocessing of graph-database queries for increased clarity and for increasing the speed and accuracy with which the queries can be formulated.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates a data model used by many graphic databases.

FIG. 7 illustrates the data contents of a node in one implementation of an LPG.

FIG. 8 illustrates the data contents of a relationship in one implementation of an LPG.

FIG. 9 shows a very small, example LPG representing the contents of a graph database that is used in the discussion and examples that follow.

FIGS. 10A-B illustrate a number of example queries that, when executed, retrieve data from the example graph database discussed with reference to FIG. 9 and that add data to the example graph database.

FIGS. 11A-B illustrates a query used to determine the current sales totals, and the average of the sales for previous years, for all the employees of the Acme corporation.

FIGS. 12A-B illustrate several of many different possible approaches to implementing graph databases.

FIGS. 13A-B provide control-flow diagrams that illustrate operation of a graph-database-management system.

FIG. 14 illustrates an execution environment and context that is initialized, in step 1320 of FIG. 13B, for execution of a query.

FIG. 15 illustrates a first improvement to graph-database-management systems disclosed in the current document.

FIG. 16 illustrates constructor-like and destructor-like functions that are automatically invoked, during query processing, for entities associated with function-valued properties, in one implementation of the currently disclosed graph-database improvement.

FIG. 17 illustrates changes to the employee nodes used to implement a solution to the above-discussed access-control problem via the above-discussed entity-associated execution environments.

FIG. 18 illustrates the start-up routine referenced by the start up property of the modified employee node, discussed above with reference to FIG. 17.

FIG. 19 illustrates the finish routine referenced by the finish property of the modified employee node, discussed above with reference to FIG. 17.

FIG. 20 illustrates the utility of a second graph-database improvement disclosed in the current document that provides for text-substitution macros that can be used to simplify query development.

FIG. 21 shows the first part of the query-processing handler routine, previously shown in FIG. 13B, with the addition of a call to query preprocessor that expands macro names included in the received query via text substitution.

FIGS. 22A-F illustrate a simple preprocessor that substitutes text for query names using the example macro facility illustrated in FIG. 20.

### DETAILED DESCRIPTION

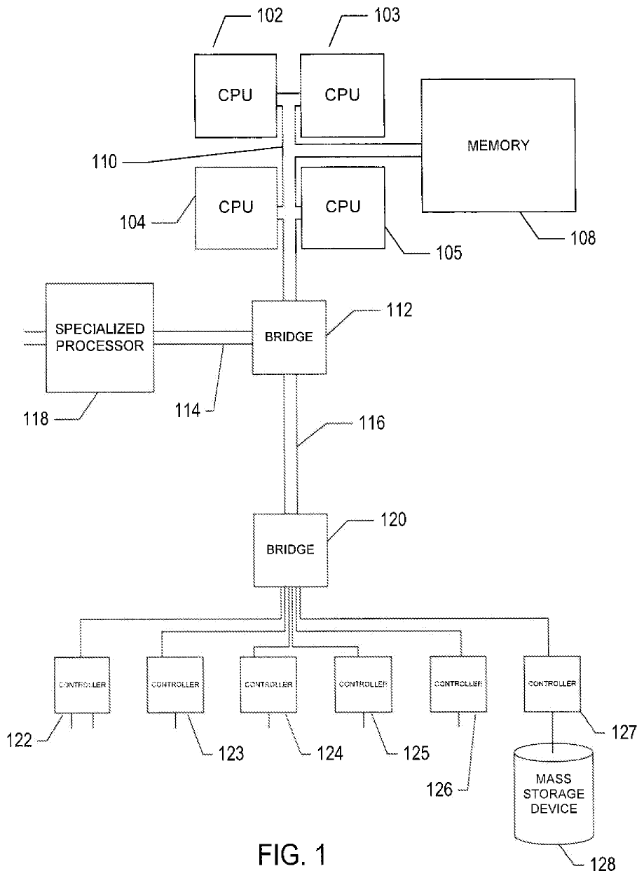

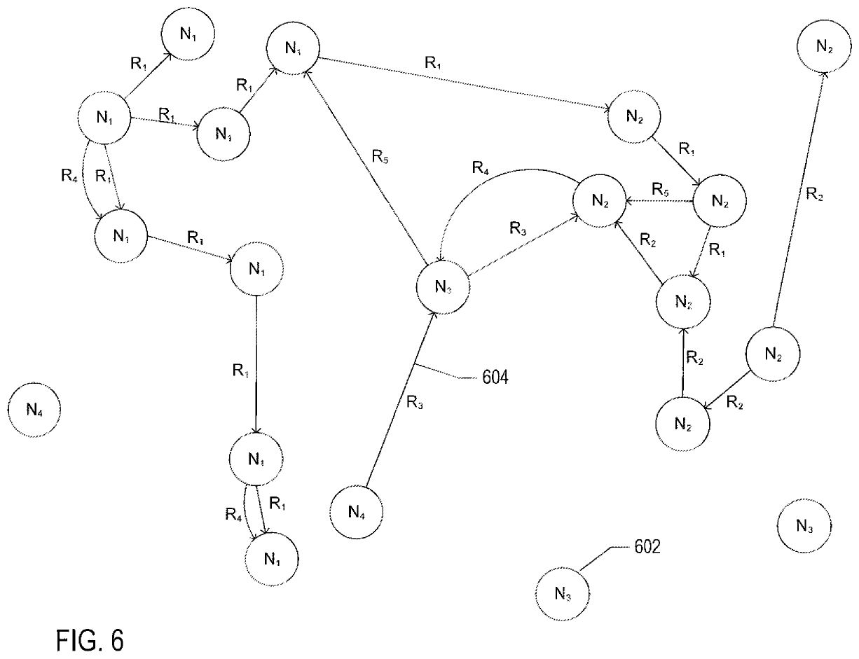

The current document is directed to is directed to graph-database improvements. In a first subsection, below, a detailed description of computer hardware, complex computational systems, and virtualization is provided with reference to FIGS. 1-5. In a second subsection, implementations of the currently disclosed improved graph database and related methods are discussed with reference to FIGS. 6-22F.

Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

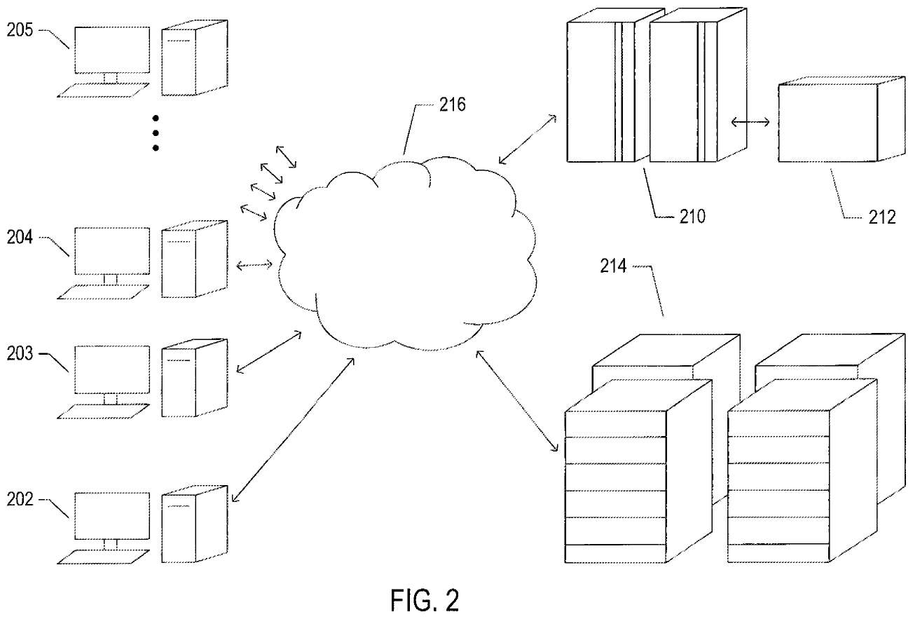

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

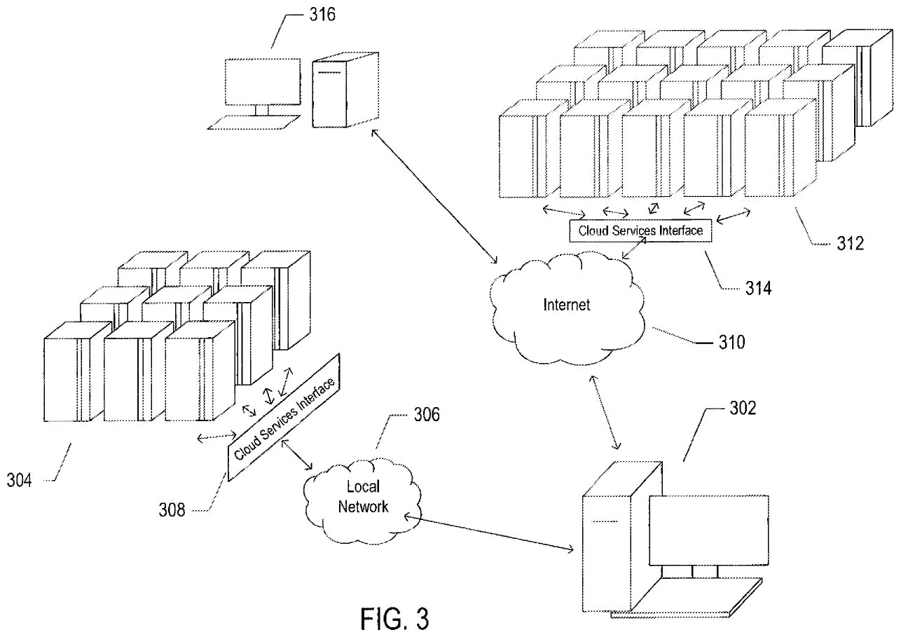

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

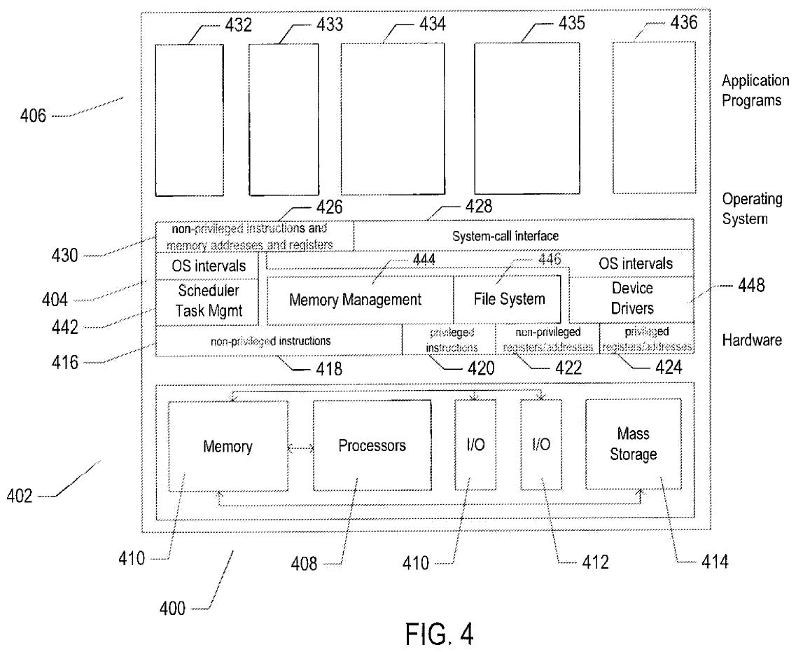

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

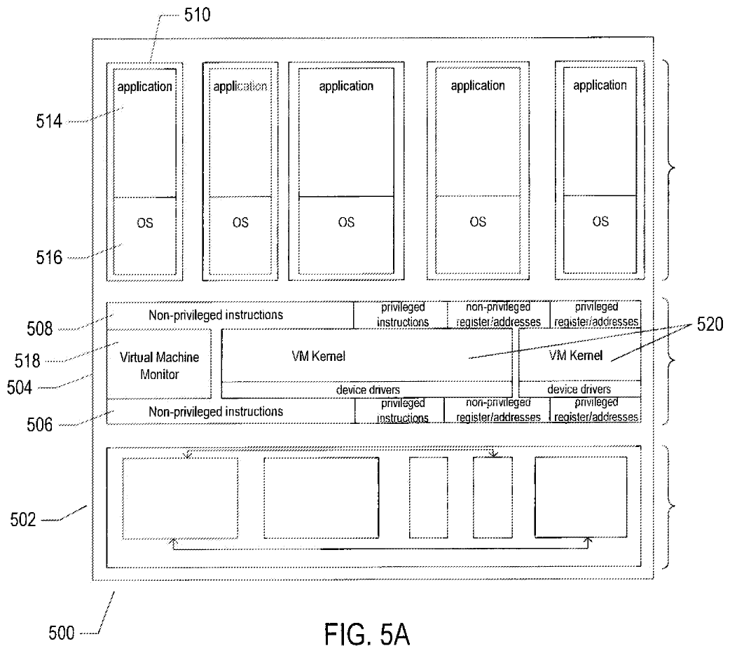

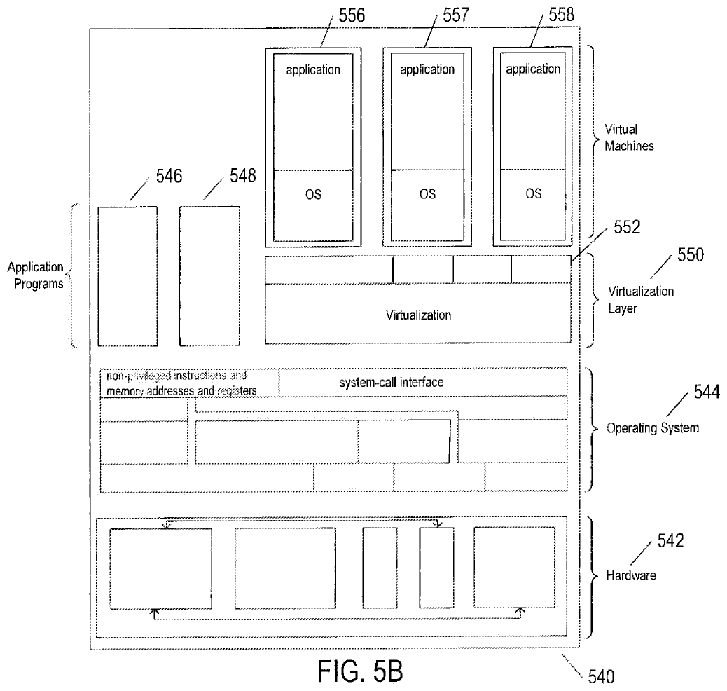

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer-hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

Disclosed Improved Graph Database and Related Methods

FIG. 6 illustrates a data model used by many graphic databases. The model is related to the mathematical concept of a graph that underlies the field of graph theory. The current document provides examples related to a particular type of graph model referred to as a “labeled property graph” (“LPG”). This is only one of many different possible types of graph models on which graph databases may be based. The currently disclosed improvements are applicable to a wide range of different graph models, but LPGs are used in the examples for clarity and brevity of the following discussion. Similarly, one particular type of graph-database query language is used in the following discussion and examples, although many different types of graph-database query languages have been developed and are current in use. The currently disclosed improvements are applicable to a wide range of different graph-database query languages.

As shown in FIG. 6, an LPG is a collection of nodes, such as node 602 labeled “N₂,” and edges or relationships, such as relationship 604 labeled “R₃.” In FIG. 6, nodes are represented by discs and relationships are represented by directed straight lines or curves that each connects two nodes. A directed straight line or curve can be thought of as an arrow pointing from a source node to a destination node. In the type of graph database used in the examples discussed in this document, the LPG stored by the graph database is not required to be fully connected. For example, node 602 is not connected to any other nodes by relationships. However, a relationship is required to connect two nodes or a given node to itself. A given node may have multiple outgoing and incoming relationships. Graph databases are particularly useful for representing social networks, organizations, complex systems, distribution networks, and other types of real-world entities that can be abstracted as a group of entities of different types interrelated by various types of relationships.

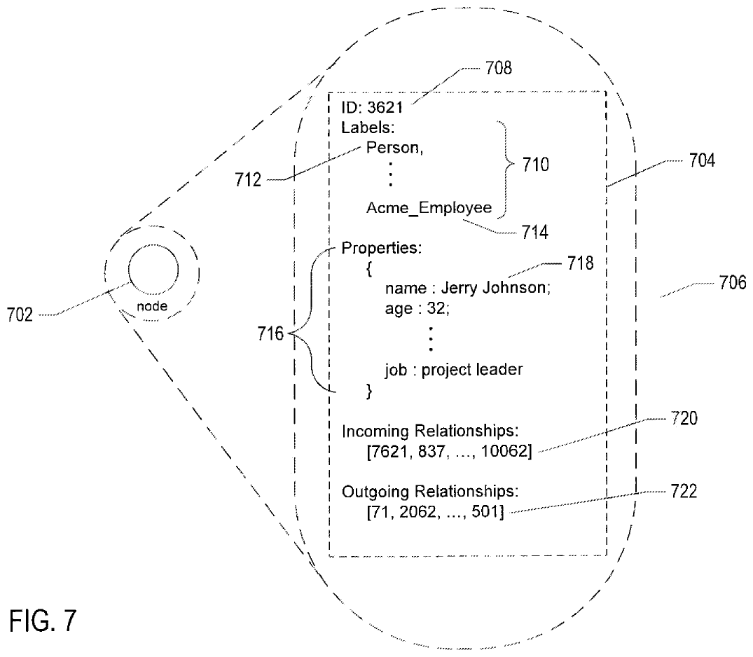

FIG. 7 illustrates the data contents of a node in one implementation of an LPG. The node 702, represented by a disk as in FIG. 6, can be considered to be a data record 704, as shown in inset 706. A node contains a unique numerical identifier 708. A node may contain 0, 1, or more labels 710. Labels may be used for a variety of different purposes. In the examples, discussed below, labels are used indicate different types and subtypes used to characterize nodes. In the example shown in FIG. 7, the node 702 represents a person 712 but also represents the Acme-employee subtype of persons 714. A node may include 0, 1, or more properties 716. Each property is a key/value pair, such as the property 718 for which the key is name and the value is “Jerry Johnson.” In general, names are alphanumeric character strings that may be further constrained to include only certain characters and may be further constrained to start with a letter, depending on the implementation. Values may be of any of various different fundamental types, such as integers, floating-point values. Unicode-character strings, and homogeneous lists, where the allowable types depend on the particular implementation. A node may contain a list of relationship identifiers 720 representing the incoming relationships, or, in other words, the relationships directed to the node, and may contain a list of relationship identifiers 722 representing the outgoing relationships, or, in other words, the relationships directed from the node to other nodes or to itself.

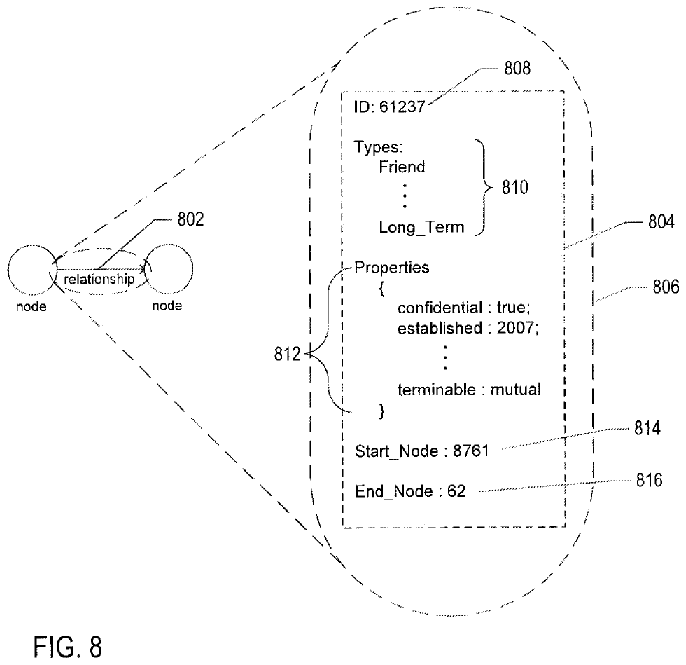

FIG. 8 illustrates the data contents of a relationship in one implementation of an LPG. The relationship 802, represented by a straight-line arrow, as in FIG. 6, can also be thought of as a data record 804, as shown in inset 806. A relationship, like a node, contains a unique numerical identifier 808. A relationship contains 0, 1, or more types 810, similar to the labels that may be contained in a node. Like a node, a relationship may contain 0, 1, or more properties 812. A relationship contains a node identifier for the source node, or start node, 814 and a node identifier for the destination node, or end node, 816 connected by the relationship.

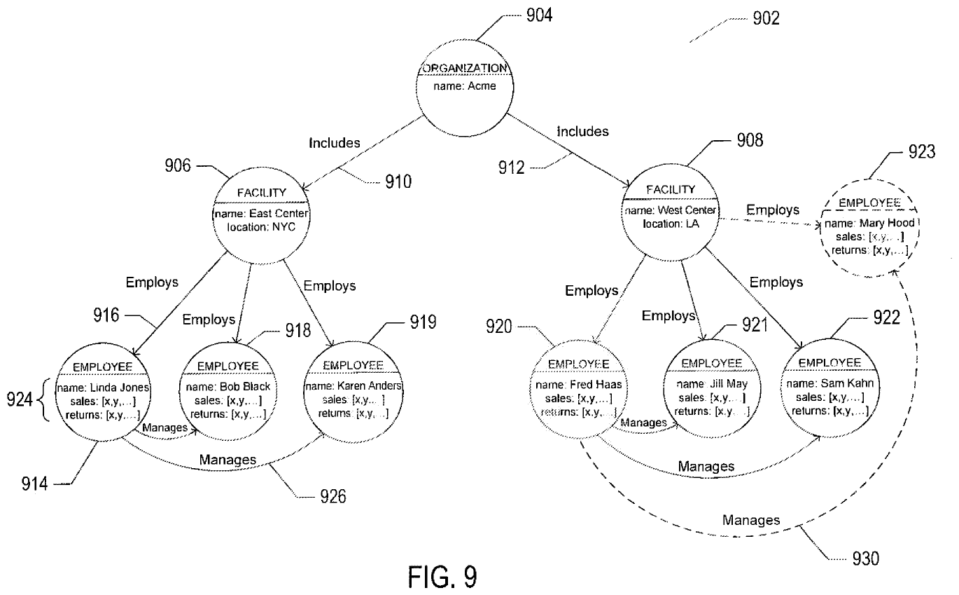

FIG. 9 shows a very small, example LPG representing the contents of a graph database that is used in the discussion and examples that follow. The LPG 902 shown in FIG. 9 includes a single node 904 with label ORGANIZATION that represents the Acme organization. This node includes a single property: name/Acme. Node 904 is connected to two nodes 906 and 908 with labels FACILITY that represent two different facilities within the Acme organization. The connections are relationships 910 and 912 with type Includes. Node 906 includes two properties: name/East Center and location/NYC. Node 908 includes two properties: name/West Center and location/LA. Each of nodes 906 and 908 are connected with multiple nodes, such as node 914, by relationships, such as relationship 916, of type Employs. The multiple nodes, including node 914, have labels Employee. These nodes 914 and 918-923 each have three properties, such as properties 924 contained in node 914, with keys: name, sales, and returns. The value of a property with key name is a character string that includes the first and last name of the employee represented by the node that includes the property. The value of a property with key sales is a list of the yearly sales totals for the employee represented by the node that includes the property. The first number, or entry, in the list represents the total sales, in dollars, for the current year, and additional entries in the list represent the total sales, in dollars, for preceding years. The value of a property with key returns is a list of the yearly total returns, in dollars, for the employee represented by the node that includes the property, with the first entry in the list representing the total returns for the current year and the remaining entries representing the terms for preceding years. Nodes 914 and 920 represent sales managers for each of the facilities, and are connected to the remaining employees at the facility by relationships of type Manages, such as relationship 926 that connects the sales manager represented by node 914 to the employee represented by node 919. The dashed-line representations of node 923 and relationships 928 and 930 are used to indicate that this node is not initially present in the LPG but is later added, using a CREATE operation, discussed below.

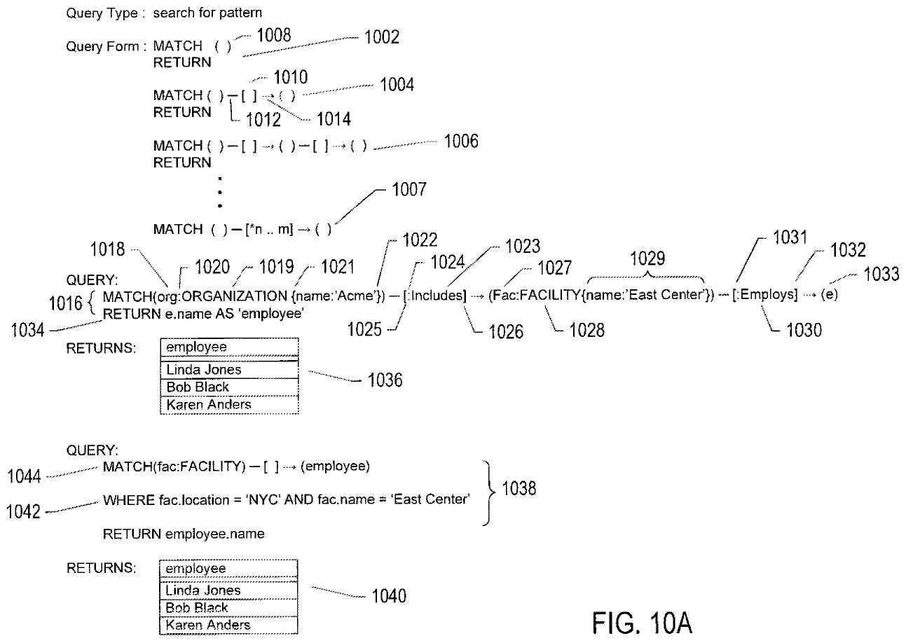

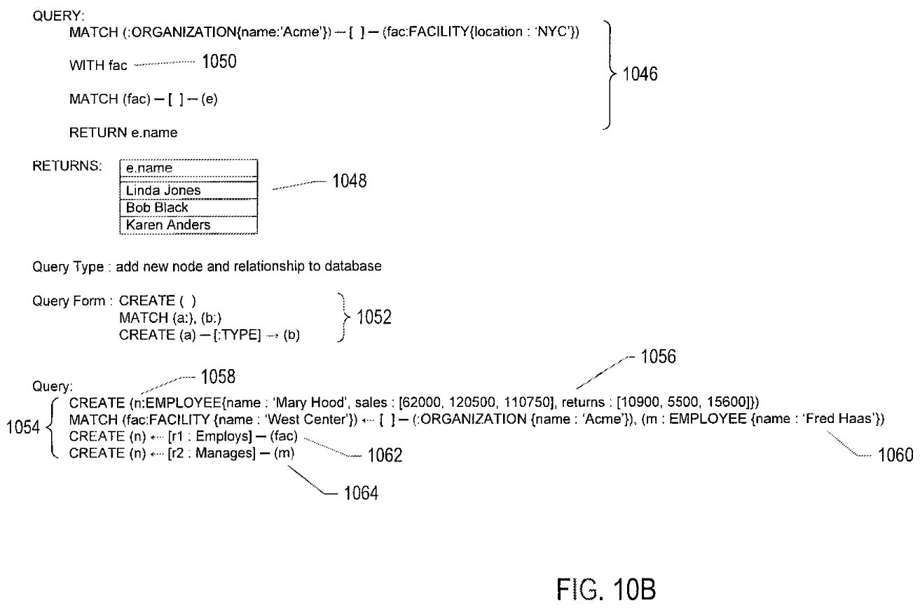

FIGS. 10A-B illustrate a number of example queries that, when executed, retrieve data from the example graph database discussed with reference to FIG. 9 and that add data to the example graph database. A first type of query illustrated in FIGS. 10A-B is a search of the graph database for a particular pattern, where the term “pattern” refers to a specification of one or more paths in the graph database. A path consists of a single node, two nodes connected by a single relationship, three nodes connected by two relationships, or longer paths of relationship-connected nodes. The search is specified by a clause beginning with the operation MATCH followed by a pattern specifying a type of path. All distinct paths in the graph database corresponding to the pattern are found in the search and are returned by a RETURN operation following the MATCH clause. Some example forms 1002-1007 of search queries are shown in the upper portion of FIG. 10A. Form 1002 is a search for one or more single nodes. A pair of complementary parentheses 1008 represents a node in a pattern. The parentheses may enclose additional information specifying constraints on the nodes in the paths that are searched for. Form 1004 specifies a search for paths comprising two nodes connected by a single relationship. The complementary brackets 1010 preceded by a hyphen 1012 and followed by a hyphen and an angle bracket that together comprise an arrow 1014 represent a relationship directed to the right. When the direction of a relationship is not important, the hyphen/angle-bracket combination can be replaced by a hyphen, with the result that the pattern matches two nodes connected in either direction by a relationship. Additional information may be included within the complementary brackets to specify constraints on the relationship in the paths that are searched for. Form 1006 specifies a search for three nodes connected by two relationships. Form 1007 specifies a search for two nodes connected by between n and m relationships and n−1 to m−1 interleaving nodes.

Next, a few example search queries are illustrated in FIGS. 10A-B. The first example query 1016 attempts to find the names of all of the employees at the East Center facility of the Acme organization. This query is of the form 1006 discussed above. The first node in the query pattern includes a query variable org 1018 to which the query successively binds the first node of the paths in the graph database during the search. The term “ORGANIZATION” 1019 following colon 1020 indicates that the first node of a matching path should contain the label ORGANIZATION, and the property within curly brackets 1021 and 1022 specify that the first node of a matching path must have the property and property value name/Acme. The term “Includes” 1023 following colon 1024 in the complementary brackets 1025 and 1026 specify that the first relationship in a matching path should have the type Includes. The second node in the query pattern includes a query variable fac 1027, and specifications of a label FACILITY 1028 and a property and property value name/East Center 1029 that the second node in a matching path must include The term “Employs” 1030 in the pair of brackets 1031-1032 indicates that the second relationship in a matching path needs to have the type Employee. The “e” 1033 in the parentheses indicating the final node of the pattern is yet another query variable. There are no constraints on the final node. The RETURN statement 1034 specifies that the value of the name property of the final node in each matching path should be returned under the heading “employee.” Execution of this query by the example graph-database-management system returns the tabular results 1036. As expected, these results are the names of all the employees working in the East Center facility of the Acme corporation. The query found three matching paths in the graph database, each path beginning with node 904, including node 906 as the middle node of the path, and including one of the three nodes 914 and 918-919 as the final node in the path.

A second example query 1038 is shown in the lower portion of FIG. 10A. This query returns the same results 1040 returned by query 1016, discussed above. However, the query has the form 1004 and uses constraints specified in a WHERE clause 1042 rather than including those constraints in the pattern specified in the MATCH clause 1044. Turning to FIG. 10B, yet a third different query 1046 also returns the same results 1048 returned by query 1038 and query 1016, discussed above. This query employs a WITH clause 1050 which acts as a pipe in a script command to funnel the results produced by a preceding clause as input to a following clause.

The lower portion of FIG. 10B shows an example query that adds a new node to the graph database. The form of the query 1052 is first illustrated. It includes an initial CREATE clause to create the new node, then a MATCH clause to set query variables to the new node and a node to connect the new node to, and, finally, a second CREATE clause to create the relationship between the new node and the node to which it is connected. Query 1054 is shown at the bottom of FIG. 10B. This query adds node 923 to the graph database shown in FIG. 9. In the first CREATE clause 1056, the new node is created. A query variable n 1058 is bound to this new node in the first CREATE clause. Next, in a MATCH clause 1060, query variables fac and m are set to nodes 908 and 920 in FIG. 9, respectively. In a second CREATE clause 1062, relationship 928 is created and, in a third CREATE clause 1064, relationship 930 is created.

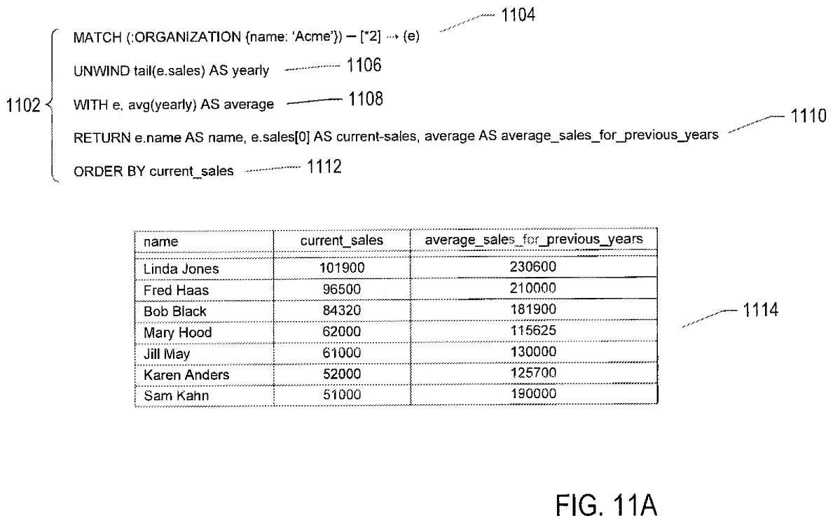

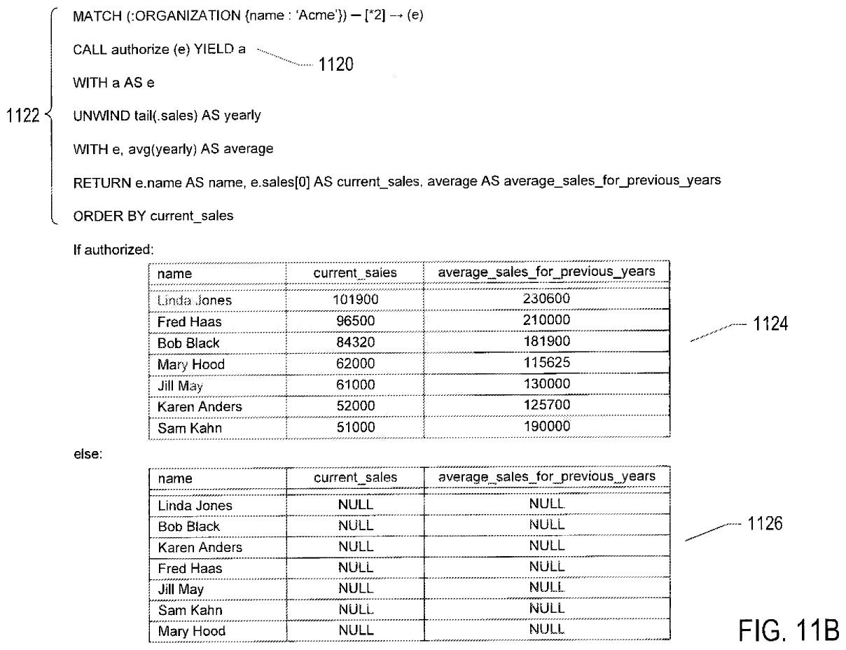

FIGS. 11A-B illustrates a query used to determine the current sales totals, and the average of the sales for previous years, for all the employees of the Acme corporation. The query 1102 includes a MATCH clause 1104 that finds all paths in the graph database leading to the different employees of the Acme corporation. The UNWIND clause 1106 turns the list value of the sales property of the employee nodes in the paths identified by the MATCH clause into a set of values bound to the query variable yearly. The WITH clause 1108 funnels the results from the MATCH and UNWIND clauses, computing averages of the sets of values bound to the query variable yearly, into the RETURN clause 1110, which returns the employee names, current sales totals, and average sales totals for previous years, with the return value triplets ordered by the current sales totals by the final ORDER BY clause 1112. The tabular results 1114 show the current sales and average sales for previous years for each of the employees.

It may well be the case that queries, such as query 1102 in FIG. 11A, should not be allowed to be executed by any user of the graph-database management system, but should instead be restricted to execution by privileged users. Employee nodes may contain many additional properties representing, for example, employee salaries, Social Security numbers, and other types of information that should, in general, be maintained in confidence and made accessible only to users given special access to such sensitive information. Many mature database-management systems, including most modern relational-database-management systems, provide complex, highly functional access-control facilities to control access to data based on access privileges distributed to users by system administrators. Currently, graph-database-management systems do not support sophisticated access controls. The types of access controls used in relational-database-management systems do not necessarily transfer to graph-database-management systems, for a variety of reasons, including the dissimilarities of the underlying data models used by these two different types of database-management systems.

Certain graph-database-management systems provide for executing functions from queries. Thus, one approach to preventing unauthorized access to sensitive information would be to develop an authorization function that would be called to gain access to search results returned by MATCH clauses. For example, such a function call could be inserted via a CALL clause 1120 within a modified version 1122 of query 1102, shown in FIG. 11B. The function authorize executed by the CALL clause would produce, from each node e, a corresponding node a with non-null property values for those properties authorized for access to the entity on behalf of which the query is executed. When no call to the function authorize is made following a MATCH clause, only the lowest-privilege-associated property values would be accessible in returned nodes and relationships. When a user is authorized to access the sales properties of employees, query 1122 would return the result 1124. Otherwise, a result such as 1126 would be returned. However, even though certain graph-database-management systems allow for stored procedures and function calls within queries, it is not clear how one could develop the authorized stored procedure hypothesized in the example shown in FIG. 11B. First, how would the function determine the identity and privileges of the user on behalf of home the query is executed? Were it up to the user to provide credentials as arguments to the authorize function, the user might attempt to provide fraudulent credentials in order to gain access to information for which the user lacks access privileges. Furthermore, for the function authorize to be effective, the query-execution logic of the graph-database-management system would need to be altered to return only lowest-privilege-associated property values and other information in returned nodes and relationships, when no call to the authorization function is made. The function would be extremely complex and hard to maintain, were different types of access to individual nodes and relationships desired. There is an even more serious problem with respect to query-execution efficiency. In certain graph-database query languages, a CALL clause must be followed by a WITH clause, which means, as discussed further below, that the output from the CALL clause needs to be temporarily stored or buffered, or generated as a stream to subsequent clauses executed asynchronously. This introduces significant computational overheads beyond the overheads associated with execution of the query 1102 shown in FIG. 11A. Inefficiencies would be compounded by multiple function calls within queries. The problems associated with attempting to provide access control to data, illustrated by the examples shown in FIG. 11A-B, points to significant deficiencies in current graph-database-management-system implementations and in the functionalities provided by current graph-database-management systems.

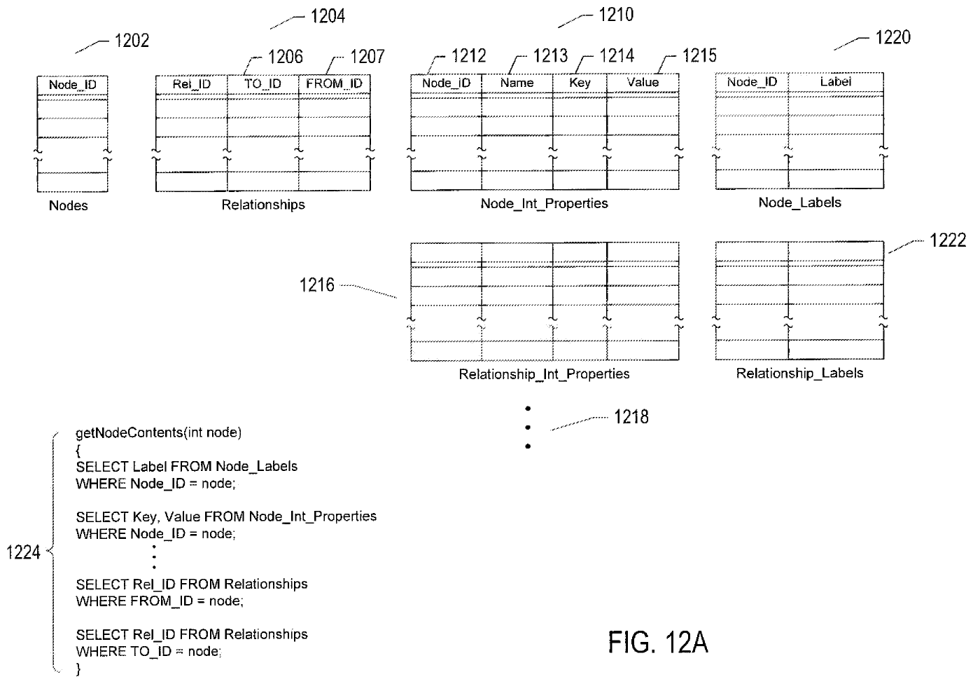

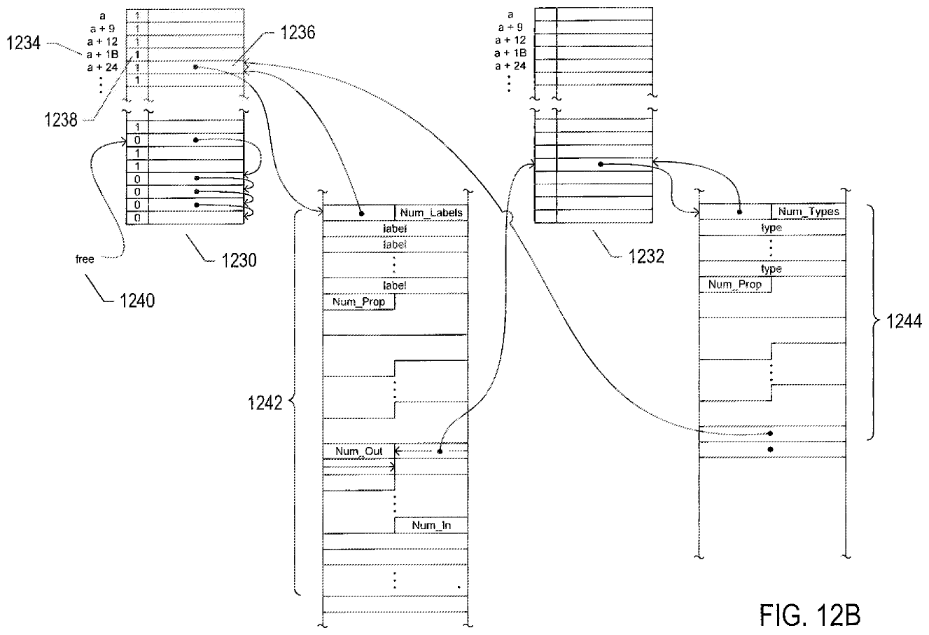

FIGS. 12A-B illustrate several of many different possible approaches to implementing graph databases. In FIG. 12A, a relational-database implementation is shown. In this implementation, node identifiers are stored in a table Nodes, in which each row represents a node and stores a node identifier for the node, and relationship identifiers are stored in a table Relationships 1204, in which each row represents a relationship. The table Relationships also stores the identifiers for the two nodes connected by each relationship in columns 1206-1207. A separate table contains the properties with values of a particular type for each node or relationship. For example, table 1210 stores the integer-valued properties for nodes. Column 1212 stores node identifiers, column 1213 stores the property names, column 1214 stores the property keys, and; 1215 stores the property values, with each row representing a single integer-valued property for a particular node. A similar table 1216 stores the integer-valued properties for relationships. Ellipsis 1218 indicates that many additional tables would be needed to store the properties having floating-point values, string values, list values, and other different value types. Labels for nodes and types for relationships are stored in tables 1220 and 1222, respectively. A pseudocode routine getNodeContents 1224 includes the structured query language (“SQL”) commands needed to retrieve information for a particular node, the identifier for which is provided as an argument to the pseudocode routine.

FIG. 12B illustrates a different type of graph-database implementation. In this implementation, node pointers are stored in data structure 1230 and relationship pointers are stored in data structure 1232. These data structures may be in-memory data structures or may be partially in-memory and partially stored on mass-storage devices, with node and relationship identifiers transferred from mass-storage devices to memory as needed, similarly to paging carried out by virtual-memory subsystems. The address of a pointer, such as the address 1234 for the data-structure entry 1236, serves as the identifier for a node. A first portion of the entry 1238 stores a flag indicating whether or not the entry corresponds to a current node, with entries not currently corresponding to nodes linked together and referenced by a free-entry pointer 1240. The pointer stored in entry 1236 points to a record 1242 stored in a node-record data structure that contains the contents of the node. Similarly, entries in the relationship data structure 1232 store pointers to relationship records, such as relationship record 1244. The record data structures may include variable-length sections to allow for efficient addition and removal of information stored in the records. These types of implementations may include many additional types of data structures, including indexes, caches, association tables, and other types of data structures that provide efficient access to, and manipulation of, the stored data. The example shown in FIGS. 12A-B indicate only two of many different possible approaches to implementing graph databases. In yet another approach, the information corresponding to an LPG is stored primarily as a very large set of key/value pairs.

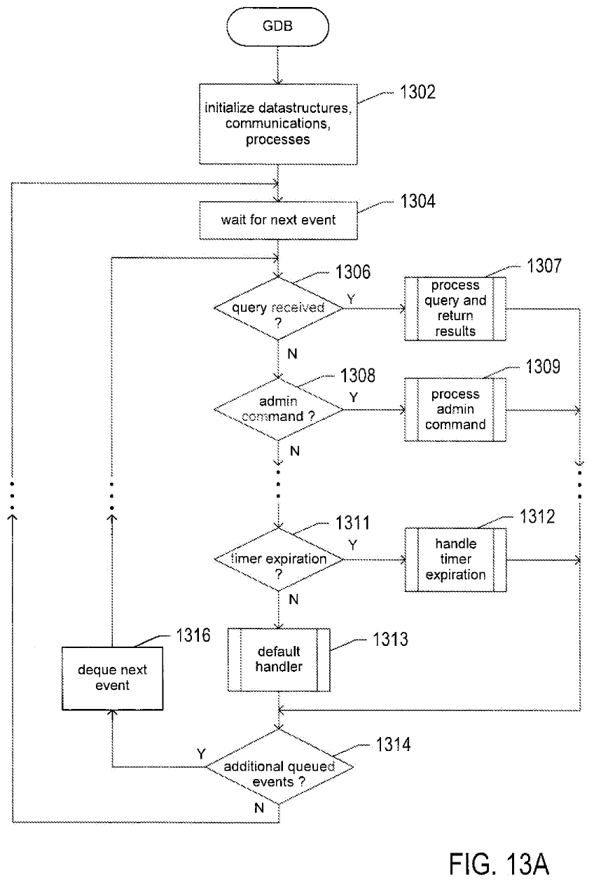

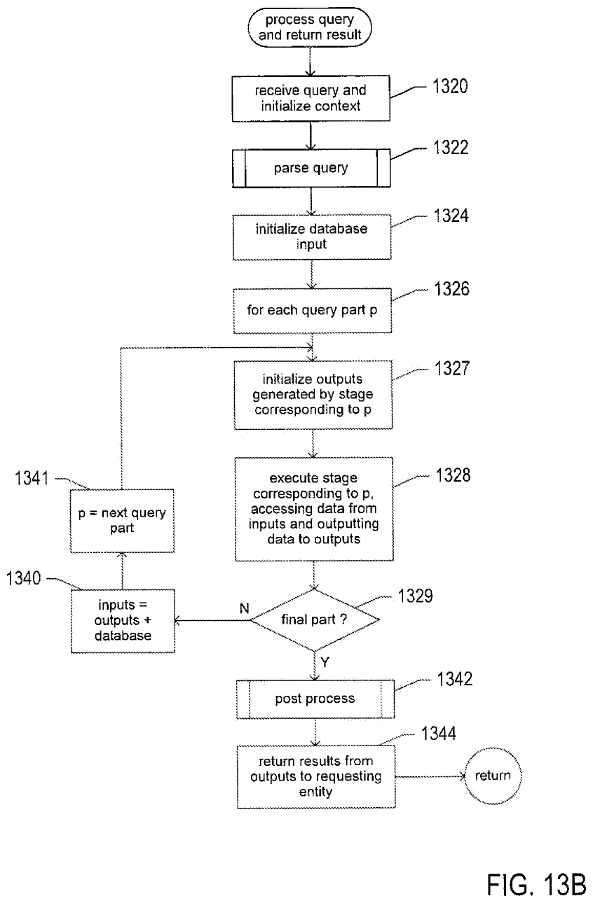

FIGS. 13A-B provide control-flow diagrams that illustrate operation of a graph-database-management system. FIG. 13A provides a control-flow diagram that illustrates an event-handling control loop that lies at the foundation of certain types of graph-database-management systems. In step 1302, upon power-on or restart, the graph-database-management system carries out various types of initialization activities, including initializing data structures, communications connections, core processes, and other run-time components. Then, in step 1304, the control loop waits for a next event to occur. Upon occurrence of a next event, a series of conditional steps is used to determine the type of event and the proper event handler to call in response to the occurrence of the event. When the event represents reception of a query from a remote client or user, as determined in step 1306, a query-processing handler is called in step 1307. Alternatively, when the event corresponds to reception of an administration command via an administration interface or consul, as determined in step 1308, an administration-command-processing handler is called in step 1309. Ellipsis 1310 indicated many other types of events may be identified and handled in the control loop. When the event represents a timer expiration, as determined in step 1311, a timer-expiration handler is called in step 1312. A default handler 1313 handles any rare or unexpected events. When additional events have occurred and have been queued for subsequent processing, as determined in step 1314, a next queued event is dequeued, in step 1316, and control returns to step 1306 to determine how the next event should be handled. Otherwise, control returns to step 1304 where the control loop waits for a next event to occur.

FIG. 13B provides a control-flow diagram for the query-processing handler called in step 1307 of FIG. 13A. In step 1320, a query is received and a query-execution environment and context are initialized for processing the query. In step 1322, the query is parsed. In step 1324, access to the graph database is initialized as the sole initial data input. In the for-loop of steps 1326-1341, each part of the query is executed. A query is divided into parts by WITH clauses, as discussed above. For each part, data outputs for the current part are initialized, in step 1327, and, in step 1328, the current execution stage corresponding to the current part is executed, during which data is accessed from the data inputs and output to the data outputs. When the current query part does not correspond to the final execution stage, as determined in step 1329, the outputs of the current execution stage become the inputs for the next execution stage, in step 1340, and the next query part is accessed in order to carry out a next iteration of the for-loop of steps 1326-1341. In step 1342, various post-processing activities are carried out, including, for example, final sorting specified by an ORDER BY clause. Finally, in step 1344, the query results are returned to the entity on behalf of which the quarry was executed.

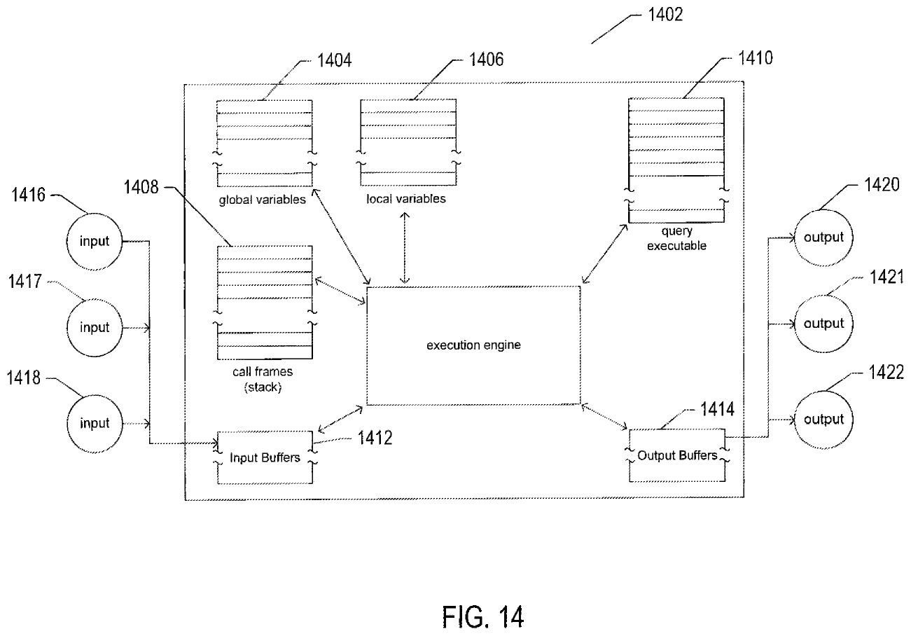

FIG. 14 illustrates an execution environment and context that is initialized, in step 1320 of FIG. 13B, for execution of a query. Depending on the implementation of the graph-database-management system, the execution environment may be a process or thread launched within a server for execution of the query, a process or thread in a pool of processes or threads waiting for a next query to execute, or other types of execution environments. The execution environment 1402 can be envisioned as a logical machine that includes stored global variables 1404, stored local variables 1406, a stack 1408 for storing call frames, stored instructions for query-processing routines 1410, data-input buffers 1412, and data-output buffers 1414. The data-input buffers 1412 receive input from the various inputs 1416-1418 for execution of the current query part and data is output from the data-output buffers 1414 to various outputs 1420-1422 for the current query part. Of course, in this context, the term “variable” means that the stored values can be overwritten, as is the case of hardware-level memory and hardware-level registers. Furthermore, local variables may be stored within the call stack, rather than comprising a separate logical memory. The inputs and outputs may be data-storage appliances, memory, streams for asynchronous execution, and other types of inputs and outputs. Of course, the details and components of an execution environment vary with different graph-database-management-system implementations, underlying operating systems and virtualization layers, hardware platforms, and other such components of the overall computing environment in which the graph-database-management system runs as well as how these components and platforms are chosen to be abstracted.

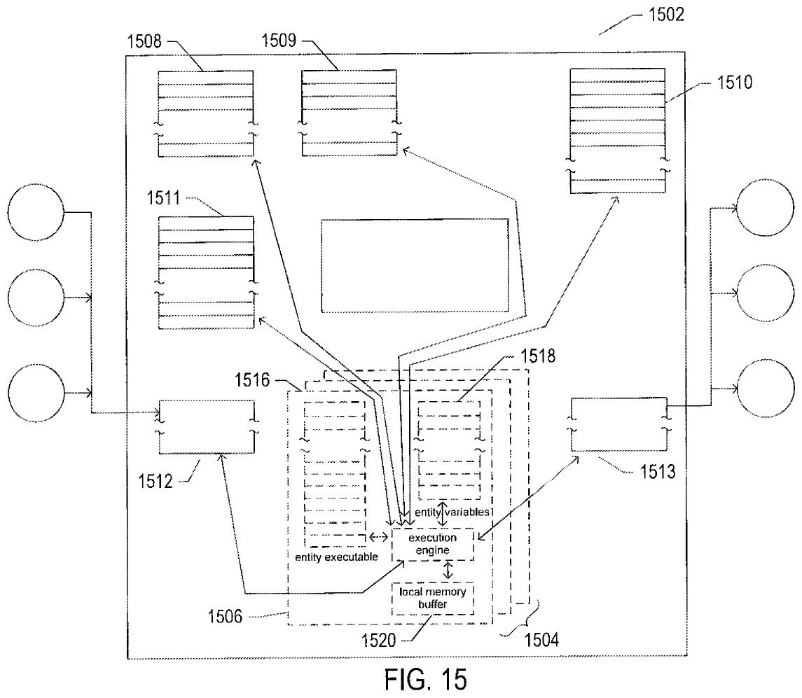

FIG. 15 illustrates a first improvement to graph-database-management systems disclosed in the current document. FIG. 15 again shows the query-execution environment and context 1502 discussed above with reference to FIG. 14. However, the improved graph-database-management system employs query-execution environments that include one or more additional entity-associated query-execution environments 1504 that execute entity-associated functions and routines for node and relationship entities that are being processed by the query-execution environment 1502. As shown in FIG. 15, an entity-associated query context 1506 can access the various above-discussed query-execution-environment components 1508-1513, but also includes stored instructions for entity-associated routines and functions 1516, additional local variables 1518, and an additional local memory buffer 1520 that are distinct from similar components in the query-execution environment. The entity-associated execution environment allows entity-associated functions and routines to be executed concurrently with graph-database-management-system query execution. Depending on the hardware and operating-system/virtualization layers underlying the graph-database management system, true parallel execution of entity-associated functions and routines may be supported. In one implementation, each node and relationship entity may include properties with function or routine values. These entity-associated functions and routines can be executed by an entity-associated execution environment while the graph-database-management system is processing the entity during data-retrieval, data-storage, and data-update operations. The ability to associate functions and routines with entities and to execute entity-associated functions and routines during query processing provides a vast increase in the functionality and flexibility of graph-database-management systems and, as discussed below, addresses the particular problem associated with developing access control, discussed above with reference to FIGS. 11A-B.

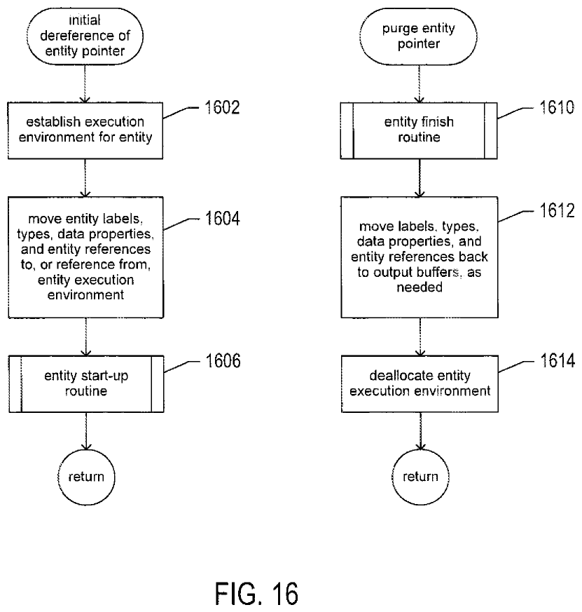

FIG. 16 illustrates constructor-like and destructor-like functions that are automatically invoked, during query processing, for entities associated with function-valued properties, in one implementation of the currently disclosed graph-database improvement. In this implementation, when the query-processing execution environment initially accesses a node or relationship entity, such as during traversal of a path within the graph database, by dereferencing a pointer or other type of reference to the entity, a constructor-like routine is automatically executed to establish an entity-associated execution environment for the entity. Similarly, when query processing no longer needs to access the entity, and therefore overwrites or purges the entity reference, a destructor-like routine is automatically executed to deallocate or free the entity-associated execution environment.

In step 1602 of the constructor-like function, the query-execution environment establishes an entity-associated execution environment for the accessed entity. This may involve assigning a currently unused entity-associated execution environment to the entity, launching a new entity-associated-execution-environment thread, or other operations, depending on the implementation. In step 1604, the entity-associated execution environment is initialized. This may involve moving entity-associated data and functions to the local variables (1518 in FIG. 15) and instruction storage (1516 in FIG. 16), initializing references to the entity-associated data and functions, or other operations that allow the entity-associated execution environment to begin executing entity-associated functions and routines. Finally, in step 1606, the entity-associated execution environment executes a start-up entity-associated routine. In step 1610 of the destructor-like function, an entity-associated finish function is automatically executed by the entity-associated execution environment for an entity that is being removed from the query-processing execution environment. In step 1612, any of the entity-associated data within the entity-associated execution environment that needs to be returned to data storage is transferred back to the query-processing execution environment, such as to output buffers the will be flushed back to the database. Then, in step 1614, the entity-associated execution environment is the deallocated, returned to an interactive-entity-associated-execution-environment pool, or otherwise inactivated, depending on the implementation.

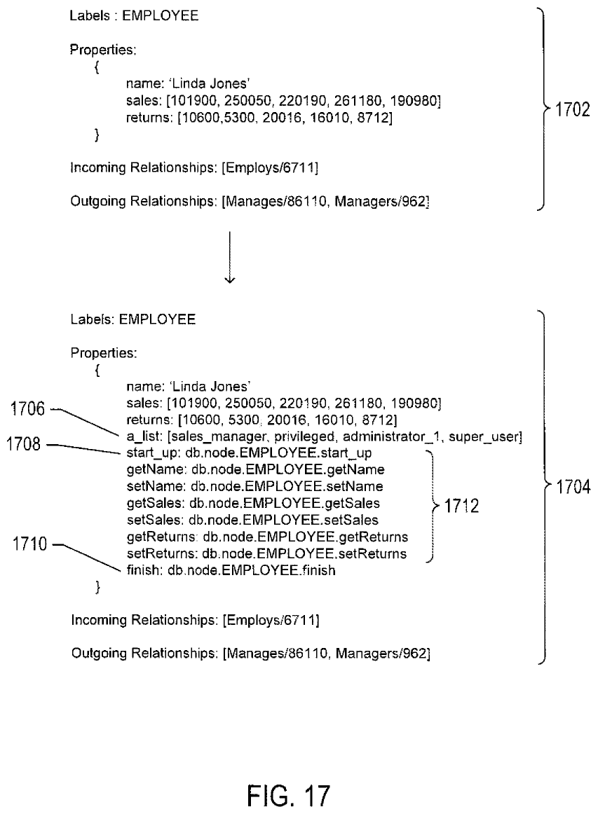

FIG. 17 illustrates changes to the employee nodes used to implement a solution to the above-discussed access-control problem via the above-discussed entity-associated execution environments. At the top of FIG. 17, the original contents 1702 of one of the employee nodes is shown. In the lower portion of FIG. 17, a modified version 1704 of the contents of the employee node is shown. In the modified version, a new property a_list 1706 is included. The value of this property is a list of access groups that are allowed to access the full data contents of the node. The modified version of the node also includes a start-up-function property 1708 and a finish-function property 1710. These properties include references to start-up and finish functions for the node, discussed above with reference to FIG. 16. Finally, the node includes a set of access-function properties 1712 that allow the query-processing execution environment to access the contents of the node within the entity-associated execution environment during query processing.

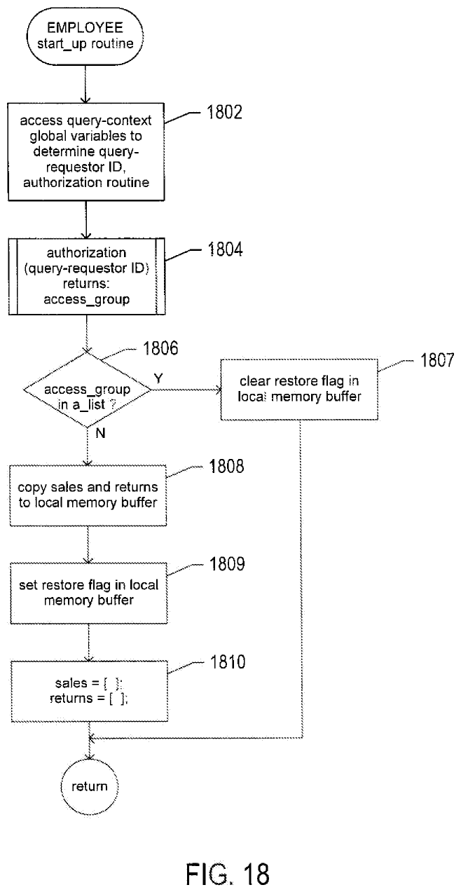

FIG. 18 illustrates the start-up routine referenced by the start_up property of the modified employee node, discussed above with reference to FIG. 17. In step 1802, the start-up routine accesses the global variables in the query-processing execution environment to determine an identifier for the user or entity on behalf of which the query is being executed by the graph-database-management system and to obtain a reference to an authorization routine. In step 1804, the start-up routine calls the authorization routine, passing to the authorization routine the identifier for the user or entity determined in step 1802. The authorization routine returns an access group for the user or entity. When the returned access group is in the list of access groups of the a list property of the node, as determined in step 1806, the user or entity on behalf of which the query is being executed may access all of the data contents of the node. Therefore, a restore flag maintained within the entity-associated execution environment is cleared, in step 1807. Otherwise, when the user or entity is not authorized access all of the data contents of the node, the list values of the sales and returns properties are copied to a local memory buffer, in step 1808, the restore flag is set, in step 1809, and the values of the sales and returns properties are set to null lists in step 1810. Thus, during query processing, the values of the sales and returns properties will not be accessible to the query-processing execution environment.

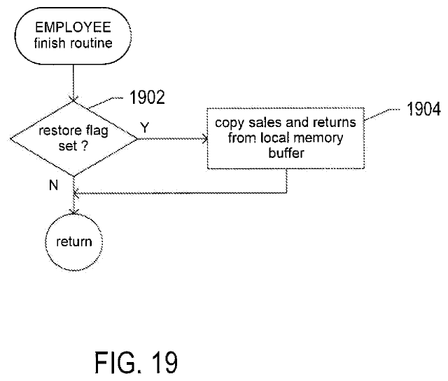

FIG. 19 illustrates the finish routine referenced by the finish property of the modified employee node, discussed above with reference to FIG. 17. When the restore flag is set, as determined in step 1902, the sales and returns property values are restored from the local memory buffer in step 1904. Thus, when the node is subsequently accessed, during query processing, on behalf of a privileged user or entity, the sales and returns property values will again be present.

The above access-control example is deliberately simple. It used to illustrate how entity-associated functions and routines can be used to solve real-world problems. Far more sophisticated access-control functionalities can be developed using entity-associated functions, entity-associated routines, and entity-associated execution environments. For example, in more sophisticated approaches, rather than simply temporarily replacing property values with null values, the properties themselves may be hidden from unauthorized users, and access control can be extended to labels, types, and outgoing and incoming relationships.

When the graph-database-management system has been improved to support entity-associated functions, entity-associated routines, and entity-associated execution environments, as discussed above with reference to FIGS. 15-19, the original query 1102 shown in FIG. 11A produces the differential results, based on user privilege, that were attempted to be produced in the example of FIG. 11B. As discussed above, that attempted solution involved adding an additional WITH clause, deleteriously impacting performance, and did not seem to be practically implementable. By contrast, entity-associated functions and routines allow for implementation of access-control functionality even at the user level, provided that users are given the tools to develop or access functions, such as the authorization function, start-up function, and finish function in the above example, that access the query-processing execution environment and context and entity-associated execution environments.

While the entity-associated-execution-environment implementation, discussed above, can be used to solve the access-control problem, many other types of new and powerful innovations and functions can be developed based on entity-associated functions, entity-associated routines, and entity-associated execution environments. The disclosed improvement provides for implementing very fine-granularity, entity-level functionalities that would be difficult or impossible to implement by functions executed at the query-processing level. Furthermore, the disclosed improvement allows for dynamic changes to the database during query processing, and certain implementations may even allow for dynamic modification of entity-associated functions and routines. The data contents of nodes and relationships may automatically change and track external conditions or may automatically adjust with respect to local phenomena reflected in the data values of adjacent entities in the graph. Although one implementation of entity-associated functions, entity-associated routines, and entity-associated execution environments is provided above, there are many different possible alternative implementations. Simple implementations may provide a single additional execution environment for a currently considered node or relationship entity during query processing and may require that entity-associated functions and routines be explicitly called by the query-processing environment, while other implementations may provide multiple entity-associated execution environments that support automated calls to certain entity-associated functions and routines, as in the above example, as well as calls to entity-associated functions and routines by users through facilities added to the query language.

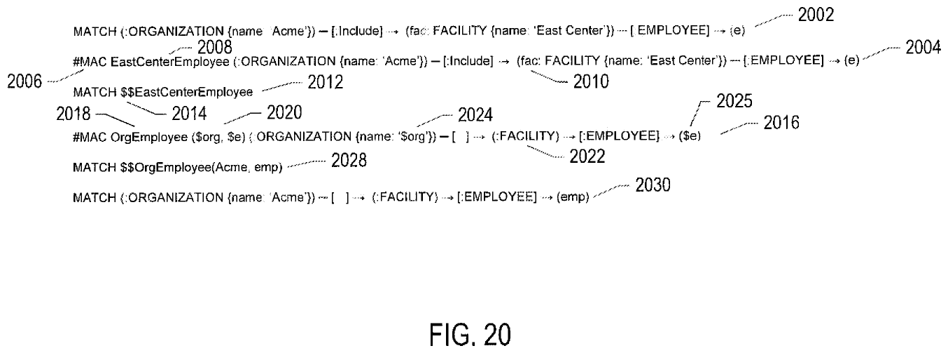

FIG. 20 illustrates the utility of a second graph-database improvement disclosed in the current document that provides for text-substitution macros that can be used to simplify query development. Consider the MATCH clause 2002 at the top of FIG. 20. This clause identifies employee nodes representing employees of the Acme corporation who work in the East Center facility and binds the identified employee nodes to a query variable e. The MATCH clause contains a great many symbols to represent a relatively simple path. In the improved graph-database-management system disclosed in the current application, a macro can be defined, as shown in example 2004 in FIG. 20. The macro definition includes a macro-declaration symbol string 2006, a macro name 2008, and the character string a query preprocessor substitutes for the macro name 2010. Thus, once the macro is defined, a user can simply type the MATCH clause 2012, and a query preprocessor will substitute the symbol string 2010 for the query name to produce MATCH clause 2002. In this implementation, macro names are recognized by being preceded with two adjacent currency symbols 2014. Macro definitions can also include variables, as illustrated by macro definition 2016. In this case, the macro name 2018 is followed by a parenthesized argument list 2020, and the replacement symbol string 2022 includes the argument names 2024-2025. The text 2028 is then expanded, by query preprocessing, to text 2030, in which the replacement text replaces the macro name and the supplied arguments “Acme” and “emp” replace the formal arguments in the replacement text. Of course, different macro-declaration symbol strings, macro-name identifier symbols, and argument-identifier symbols may be used in different implementations. Macro definitions may be typed into a query editor or may be included from macro-definition files. A macro facility may include many additional features, including control structures such as if-else control structures, nested substitutions, and other features that provide complex types of symbol replacement and expression generation.

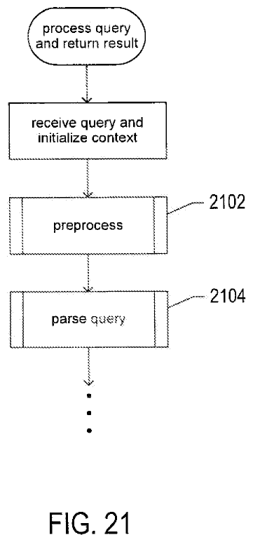

FIG. 21 shows the first part of the query-processing handler routine, previously shown in FIG. 13B, with the addition of a call to a query preprocessor that expands macro names included in the received query via text substitution. The preprocessing step 2102 occurs prior to the query-parsing step 2104. In certain implementations, the preprocessor may identify and flag various types of errors introduced by macros while, in other implementations, the errors are detected when the text-substituted query is parsed, in step 2104.

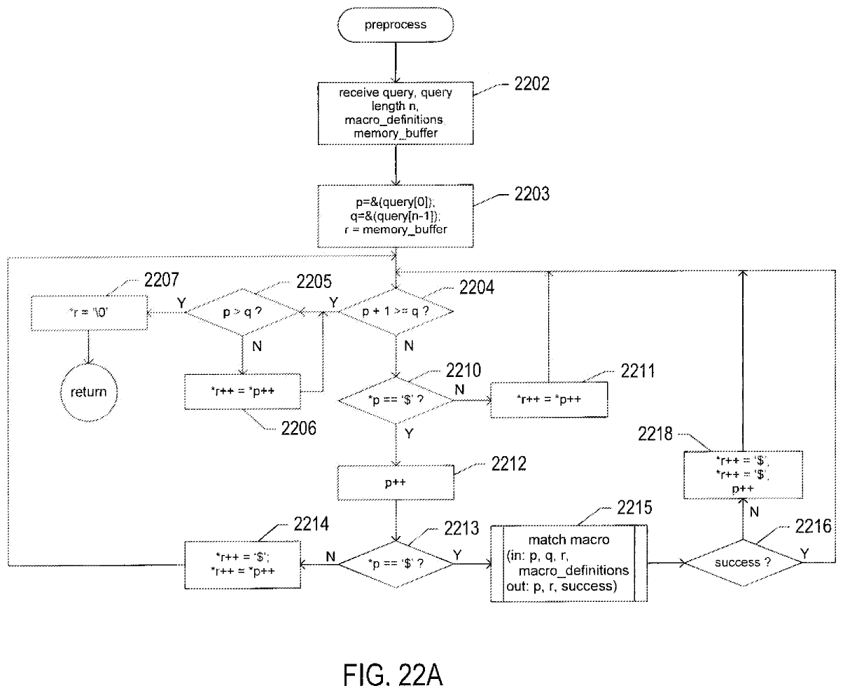

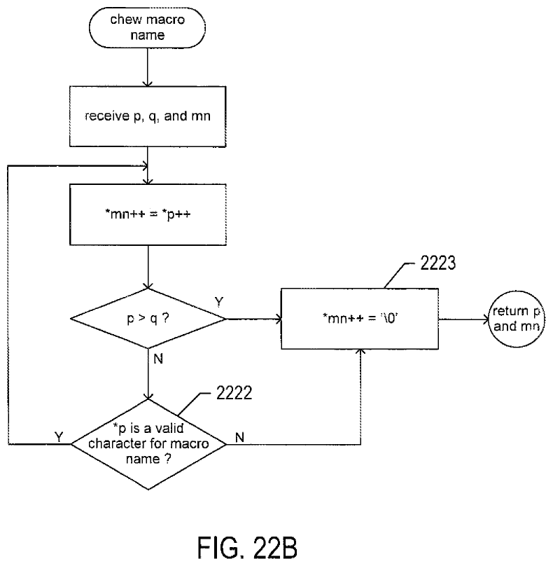

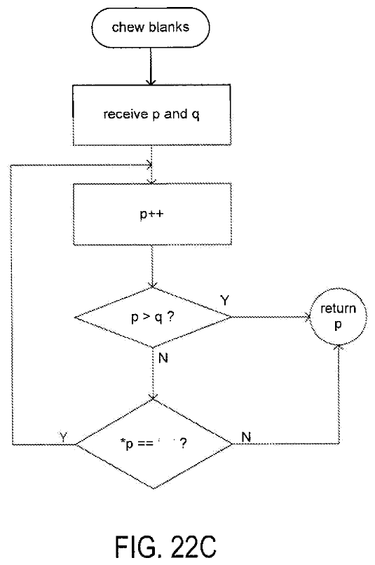

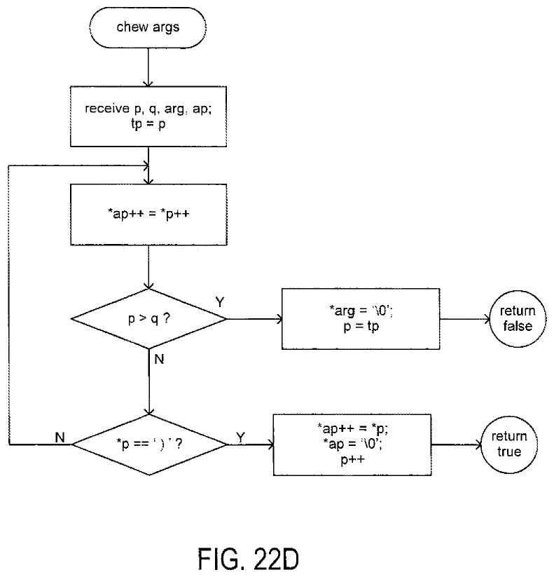

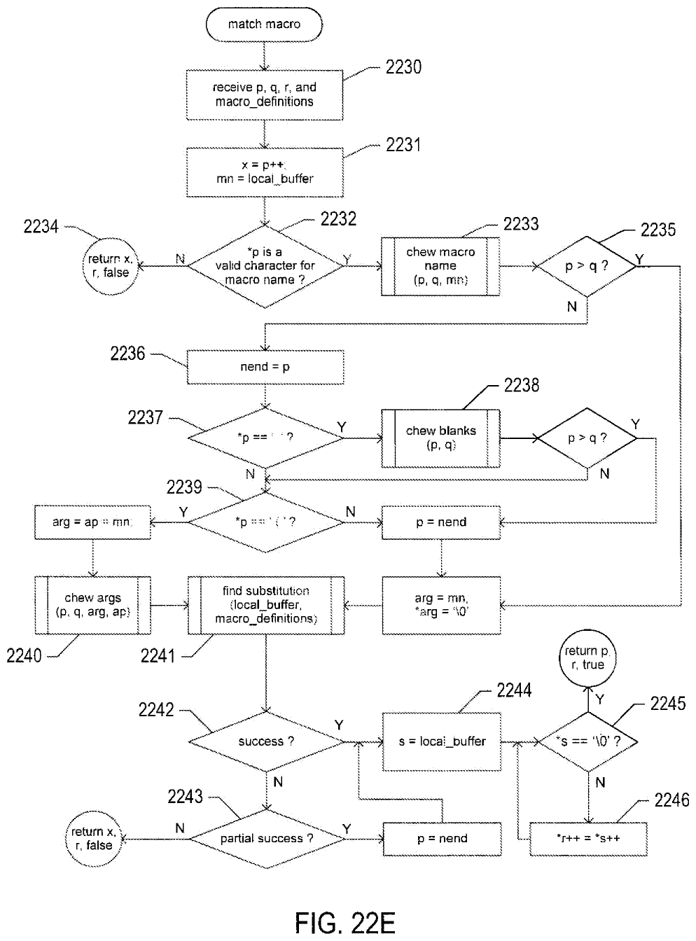

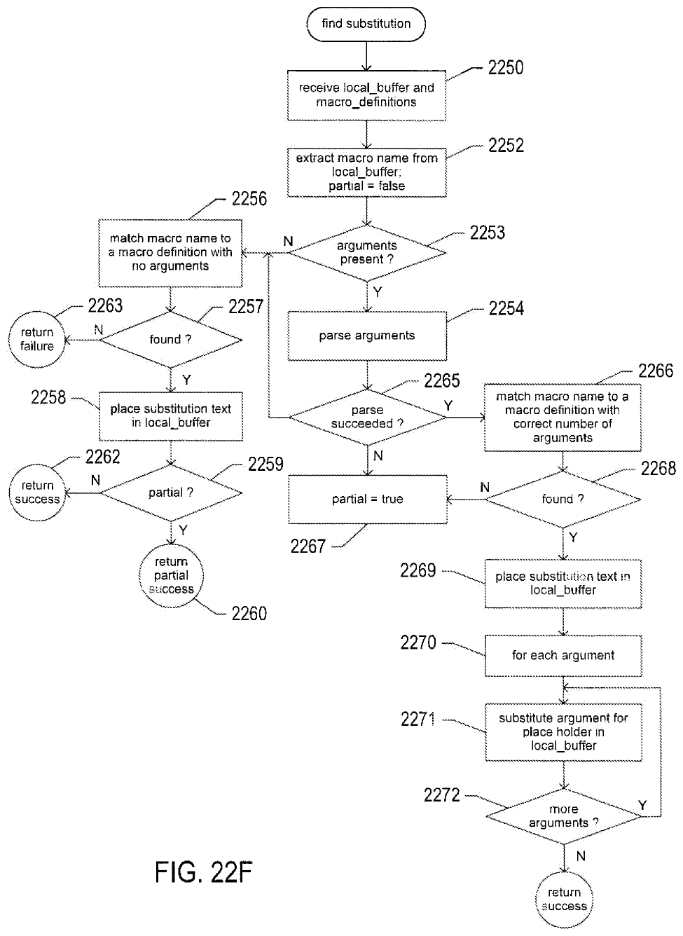

FIGS. 22A-F illustrate a simple preprocessor that substitutes text for query names using the example macro facility illustrated in FIG. 20. FIG. 22A illustrates the preprocessing routine. In step 2202, a query is received, along with the length of the query, a reference to the macro definitions, and a reference to a memory buffer into which the text-substituted query is placed. In step 2203, a pointer variable p is set to point to the first character in the query, the pointer variable q is set the point to the final character in the query, and the pointer variable r is set to point to the beginning of the memory buffer. When there are insufficient remaining characters in the query from the character pointed to by the variable p to the end of the query pointed to by pointer variable q for a query name preceded by a query-name-identifier symbol string, as determined in step 2204, the remaining symbols are copied to the memory buffer to complete the text-substituted query, in steps 2205-2207. Otherwise, when the currently considered character referenced by the variable p is not a currency symbol, as determined in step 2210, the currently considered character is copied to the memory buffer, in step 2211, and variables r and p are incremented. Otherwise, in step 2212, p is incremented and, in step 2213, the preprocessor determines whether or not p currently references a second currency symbol. If not, the first recognized currency symbol is copied to the memory buffer followed by the currently considered symbol, in step 2214. Otherwise, a routine “match macro” is called, in step 2215, to attempt to match the text that follows the double currency symbols to a macro name and, if provided, macro arguments, and to then -replace the macro name and arguments, if provided, with substitution text. If the routine “match macro” successfully replaces a macro name and, if provided, macro arguments, as determined in step 2216, control returns to step 2204 to continue processing the query. Otherwise, the currency symbols are added to the memory buffer, in step 2218, prior to control returning to step 2204. In this case, it is probable that an error was introduced into the query which will be later caught during query processing.

FIG. 22B provides a control-flow diagram for a routine “chew macro name” that places the characters of a macro name included in a query into a buffer location pointed to by the argument nm. Successive characters that are valid characters for a macro name, as determined in step 2222, are read from the query. Once the name has been read into the memory buffer, a trailing null character is added to the end of the macro name, in step 2223.

FIG. 22C provides a control-flow diagram for a routine “chew blanks” that skips over a sequence of blank or white space characters. This routine is called when the variable p is currently referencing a white space character.

FIG. 22D provides a control-flow diagram for a routine “chew args” that places parentheses-enclosed text into a location of a memory buffer referenced by the argument “arg.” This routine is called when the variable p is currently referencing a left-parenthesis symbol.

FIG. 22E provides a control-flow diagram for the routine “match macro,” called in step 2215 of FIG. 22A. The routine receives pointer variables p, q, r and a reference to the macro definitions in step 2230. In step 2231, the current value of the variable p is stored in a local variable x and a local variable mn is set to point to a local memory buffer. When the currently considered character is a valid character for a macro name, as determined in step 2232, the routine “chew macro name” is called, in step 2233, to identify and transfer a macro name to the local memory buffer. Otherwise, the routine “match macro” returns, in step 2234. If there are characters in the query following the macro name, as determined in step 2235, the current value of the variable p is recorded in a local variable nend, in step 2236. When the currently considered character is a white space character, as determined in step 2237, the routine “chew blanks” is called, in step 2238. When there are additional characters in the query following the white space, and the currently considered character is a left-parenthesis symbol, as determined in step 2239, the routine “chew args” is called, in step 2240, to place the parenthesised arguments for the macro, if any, into the local memory buffer following the macro name. The routine “find substitution” is called, in step 2241, to find the replacement text for the macro name and for the macro arguments, if provided. When the routine “find substitution” returns a success indication, as determined in step 2242, or when the routine “find substitution” returns a partial-success indication, as determined in step 2243, which means that only a macro name, without arguments, was found and replaced, rather than the expected macro name with arguments, the substitution text is entered into the text-substituted query, in steps 2244-2246.

FIG. 22F provides a control-flow diagram for the routine “find substitution” called in step 2241 of FIG. 22E. In step 2250, the routine “find substitution” receives a pointer to the local buffer used by the “match macro” routine and a reference to the macro definitions. In step 2252, the routine “find substitution” extracts the macro name from the local buffer and sets a local variable partial to false. When there are arguments for the macro in the local buffer, as determined in step 2253, control flows to step 2254. Otherwise, in step 2256, the macro name is attempted to be matched to a macro definition. When a match is found, as determined in step 2257, the substitution text for the macro is placed into the local buffer, in step 2258. When the local variable partial is true, as determined step 2259, the routine “find substitution” returns an indication of partial success 2260. Otherwise, the routine returns an indication of success in step 2262. When a matching macro definition is not found, the routine “find substitution” returns an indication of failure, in step 2263. When arguments are present, the arguments are parsed in step 2254. When the parse succeeds, as determined in step 2265, control flows to step 2266. Otherwise, variable partial is set to true, in step 2267, and control flows to step 2256. In step 2266, the macro name is attempted to be matched to a macro declaration with the proper number of arguments. When an appropriate macro definition is found, as determined in step 2268, control flows to step 2269. Otherwise, control flows to step 2267. In step 2269, the substitution text for the macro is placed in the local buffer and, in the for-loop of steps 2270-2272, the literal arguments are substituted for the formal arguments.

Although the present invention has been described in terms of particular embodiments, it is not intended that the invention be limited to these embodiments. Modifications within the spirit of the invention will be apparent to those skilled in the art. For example, any of a variety of different implementations of the improved graph-database-management system can be obtained by varying any of many different design and implementation parameters, including modular organization, programming language, underlying operating system, control structures, data structures, and other such design and implementation parameters. As discussed above, there are many different possible implementations of entity-associated functions, entity-associated routines, and entity-associated execution contexts which provide a wide range of functionalities. As also discussed above, many different types of functionalities can be included in a macro preprocessor. The various symbol strings used to indicate macro definitions, macro names in query text, and formal and literal macro arguments may vary from implementation to implementation.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An improved graph-database-database-management system comprising:
one or more processors;
one or more memories;
a graph database that stores node entities and relationship entities, and
computer instructions, stored in one or more of the one or more memories that, when executed by one or more of the one or more processors, control the graph-database-database-management system to
receive a query,
initialize a query-processing execution environment that executes the received query, and
during execution of the query,
access one of the node entities and relationship entities,
initialize an entity-associated execution environment for the accessed entity, and
execute, in the entity-associated execution environment, one or more entity-associated functions and/or routines on behalf of the accessed entity.

2. The improved graph-database-database-management system of claim 1 wherein the quern-processing execution environment comprises:
global variables;
local variables;
query-execution instructions;
a call stack; and
one or more input and/or output buffers.

3. The improved graph-database-database-management system of claim 2 wherein the entity-associated execution environment comprises:
local entity-associated variables; and
entity-associated-function and/or entity-associated-routine instructions.

4. The improved graph-database-database-management system of claim 3 wherein the one or more entity-associated functions and/or routines executing within the entity-associated execution environment access one or more of the global variables and local variables within the query-processing execution environment.

5. The improved graph-database-database-management system of claim 1 wherein one or more of the node entities and/or relationship entities includes one or more properties, each having an entity-associated-function or an entity-associated routine value.

6. The improved graph-database-database-management system of claim 5 wherein, during query execution, a query-processing function or routine executing within the query-processing execution environment calls an entity-associated function or routine that executes in the entity-associated execution environment.

7. The improved graph-database-database-management system of claim 5
wherein the query includes a call to an entity-associated function or routine; and
wherein the call to the entity-associated function or routine in the query is processed by a query-processing function or routine executing within the query-processing execution environment which, in processing the call in the query, launches execution of the called entity-associated function or routine within the entity-associated execution environment.

8. The improved graph-database-database-management system of claim 1 wherein, during execution of the query, query-processing functions and routines executing within the query-processing execution environment traverse paths comprising multiple node entities connected by relationship entities within the graph database, successively accessing each of the multiple node entities and relationship entities in the path during traversal of the path.

9. The improved graph-database-database-management system of claim 8 wherein, when one of the query-processing functions and routines first accesses a node entity or relationship entity during a path traversal, an entity-associated execution environment is initialized for the accessed entity and an entity-associated function or routine associated with the accessed entity is automatically executed on behalf of the accessed entity.

10. The improved graph-database-database-management system of claim 9 wherein, when the query-processing functions and routines no longer access the accessed entity during the path traversal, an entity-associated function or routine associated with the accessed entity is automatically executed on behalf of the accessed entity, after which the entity-associated execution environment is deallocated or freed for use by a different entity within the path.

11. The improved graph-database-database-management system of claim 1 wherein multiple entity-associated execution environments are concurrently initialized to support concurrent execution of multiple entity-associated functions and/or routines on behalf of multiple graph-database entities.

12. The improved graph-database-database-management system of claim 1 wherein the graph-database-management system further comprises a query preprocessor that identifies macro names and macro names accompanied by arguments within queries and substitutes, for the identified macro names and macro names accompanied by arguments, replacement text specified in macro declarations.

13. A method that provides concurrent execution of entity-associated functions and routines during execution of queries by a graph-database management system, the method comprising:
receiving a query,
initializing a query-processing execution environment that executes the received query, and
during execution of the query,
accessing one of a node entity and relationship entity within the graph database,
initializing an entity-associated execution environment for the accessed entity, and
executing one or more entity-associated functions and/or routines on behalf of the accessed entity.

14. The method of claim 13 wherein the query-processing execution environment comprises:
global variables;
local variables;
query-execution instructions;
a call stack; and
one or more input and/or output buffers.

15. The method of claim 14 wherein the entity-associated execution environment comprises:
local entity-associated variables; and
entity-associated-function and or entity-associated-routine instructions.

16. The method of claim 14 wherein one or more entity-associated functions and routines executing within the entity-associated execution environment access one or more of the global variables and local variables within the query-processing execution environment.

17. The method of claim 13 further comprising:
providing query functionality that creates node entities and relationship entities that include one or more properties, each having an entity-associated-function or an entity-associated routine value.

18. The method of claim 17 further comprising:
during execution of the query, calling, by a query-processing function or routine executing within the query-processing execution environment, an entity-associated function or routine that executes within the entity-associated execution environment.

19. The method of claim 17 further comprising:
during execution of the query,
processing, by a query-processing function or routine executing within the query-processing execution environment, a query that includes a call to an entity-associated function or routine, and
launching execution of the called entity-associated function or routine within the entity-associated execution environment.

20. The method of claim 13 further comprising:
identifying, by a query preprocessor, macro names and macro names accompanied by arguments within queries; and
substituting, by the query preprocessor, replacement text specified in macro declarations for the identified macro names and macro names accompanied by arguments.

21. A physical data-storage device that stores computer instructions that, when executed by a graph-database-management system having one or more processors, one or more memories, and a graph database that stores node entities and relationship entities, controls the graph-database-management system to
receive a query,
initialize a query-processing execution environment that executes the received query, and
during execution of the query,
access one of a node entity and relationship entity within the graph database,
initialize an entity-associated execution environment for the accessed entity, and
execute one or more entity-associated functions and routines on behalf of the accessed entity.
